(19) United States
(12) Patent Application Publication
(10) Pub. No.: US 2014/0153024 A1
(43) Pub. Date: Jun. 5, 2014

(54) DATA PRINTING SYSTEM AND DATA PROTECTION METHOD THEREOF

(71) Applicant: KINPO ELECTRONICS, INC., New Taipei City (TW)

(72) Inventor: Wu-Chieh Chen, New Taipei City (TW)

(73) Assignee: KINPO ELECTRONICS, INC., New Taipei City (TW)

(21) Appl. No.: 13/773,651

(22) Filed: Feb. 22, 2013

(30) Foreign Application Priority Data
Dec. 5, 2012 (TW) 101145698

(51) Int. Cl. G06K 15/02

(52) U.S. Cl. CPC G06K 15/025
USPC 358/1.14

(57) ABSTRACT

A data printing system and data protection method thereof are provided. The system includes a data output device and a data printing device. The data output device transfers data into a printing file that includes a plurality of file blocks. Also, the data output device sequentially classifies the file blocks into a plurality of sections with a preset number, and respectively generates a plurality of checksums according to the file blocks in each section. The data output device respectively appends the checksums to the sections and sequentially transmits the sections. The data printing device is connected to the data output device through a connecting interface, receives the sections and examines whether the file blocks in each section are correct according to the checksum of each section respectively. When the file blocks of each section are correct, the data printing device executes a printing job corresponding to the section.

### CROSS-REFERENCE TO RELATED APPLICATION

This application claims the priority benefit of Taiwan application serial no. 101145698, filed on Dec. 5, 2012. The entirety of the above-mentioned patent application is hereby incorporated by reference herein and made a part of this specification.

### BACKGROUND

1. Technical Field

The invention is related to a data printing device and data protection method thereof.

2. Background

When, for example, an electronic device such as a personal computer intends to print a document through a printer, a print control module (such as a printer driver) in the electronic device transmits the printing data to the printer through a transmission interface. However, due to the instability of the transmission interface or other uncertain factors, the printer may receive erroneous printing data. Erroneous printing data may lead the printer to print unexpected data or images and thus waste papers, and even lead to conditions such as the printer crashing.

### SUMMARY

A data printing system and data protection method thereof are provided, capable of effectively ensuring the correctness of printing data.

A data printing system is provided, including a data output device and a data printing device. The data output device transfers data into a printing file that includes a plurality of file blocks. The data output device sequentially classifies the file blocks into a plurality of sections with a preset number, and generates a plurality of checksums respectively according to the file blocks in each section. The data output device appends the checksums to corresponding sections respectively and transmits the sections sequentially. The data printing device is connected to the data output device through a connecting interface, receives the sections and examines whether the file blocks in each section are correct according to the checksum of each section respectively. Therein, when the file blocks of each section are correct, the data printing device executes a printing job corresponding to the section.

According to an embodiment of the invention, when the file blocks of each section are incorrect, the data printing device cancels the current printing job immediately and processes the next printing job.

In the embodiment of the invention, when the file blocks of each section are incorrect, the data printing device sends a data error message to the data output device.

According to an embodiment of the invention, the data output device includes a print control unit, a checksum generating unit, and an output unit. The print control unit receives data and transfers the data into a printing file that includes a plurality of file blocks. The checksum generating unit is coupled to the print control unit, receives the file blocks and sequentially classifies the file blocks into a plurality of sections with a preset number, and generates a plurality of checksums respectively according to the file blocks in each section. The checksum generating unit appends the checksums to corresponding sections respectively. The output unit is coupled to the checksum generating unit, receives the sections sequentially from the checksum generating unit, and outputs the sections sequentially through a connecting interface.

According to an embodiment of the invention, the data printing device includes an input unit, an analysis unit, and an imaging unit. The analysis unit is coupled to the input unit, controls the input unit to receive the sections from the connecting interface. The analysis unit analyzes the sections, and examines whether the file blocks in each section are correct according to the checksum of each section respectively. The imaging unit is coupled to the analysis unit. When the file blocks in the sections are correct, the imaging unit receives the file blocks from the analysis unit, and executes a printing job with the file blocks.

According to an embodiment of the invention, each file block includes a printing order and segmented data. Also, a printing job includes that the imaging unit renders the segmented data in one of the file blocks according to the printing order in the file block and prints the rendered segmented data when receiving the file block.

According to an embodiment of the invention, a transmission interface is an Ethernet, a wireless local area network, a Universal Serial Bus (USB), a firewire interface (IEEE 1394), an external Serial Advanced Technology Attachment (eSATA), a Thunderbolt interface, a PS/2 interface, a COM PORT interface, a blue tooth interface or an RJ45 interface.

A data protection method is provided, suitable for a data output device, and the method includes the following steps. First, transfer data into file blocks. Then, sequentially classify the file blocks into a plurality of sections with a preset number. Next, generate a plurality of checksums according to the file blocks in each section and append the checksums to the corresponding sections respectively. Furthermore, transmit the sections to a data printing device sequentially through a connecting interface, so that the data printing device may examine whether the file blocks in each section are correct according to the checksum in each section.

Based on the above, the invention provides a data printing system and a data protection method thereof, wherein data for printing are classified into a plurality of sections and corresponding checksums are appended respectively, so that the data printing device may examine the correctness of the file blocks according to the checksums to avoid printing unexpected data or images and to maintain the stability of the data printing device.

In order to make the aforementioned features and advantages of the disclosure more comprehensible, embodiments accompanied with figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a sequential flowchart of a data printing system illustrated according to an embodiment of the invention.

FIG. 2 is a functional block diagram of a data printing system illustrated according to an embodiment of the invention.

FIG. 3 is a schematic data structural view of the sections, file blocks and checksums illustrated according to an embodiment of the invention.

FIG. 4 is a method flowchart of a data protection method illustrated according to an embodiment of the invention.

### DETAILED DESCRIPTION OF DISCLOSED EMBODIMENTS

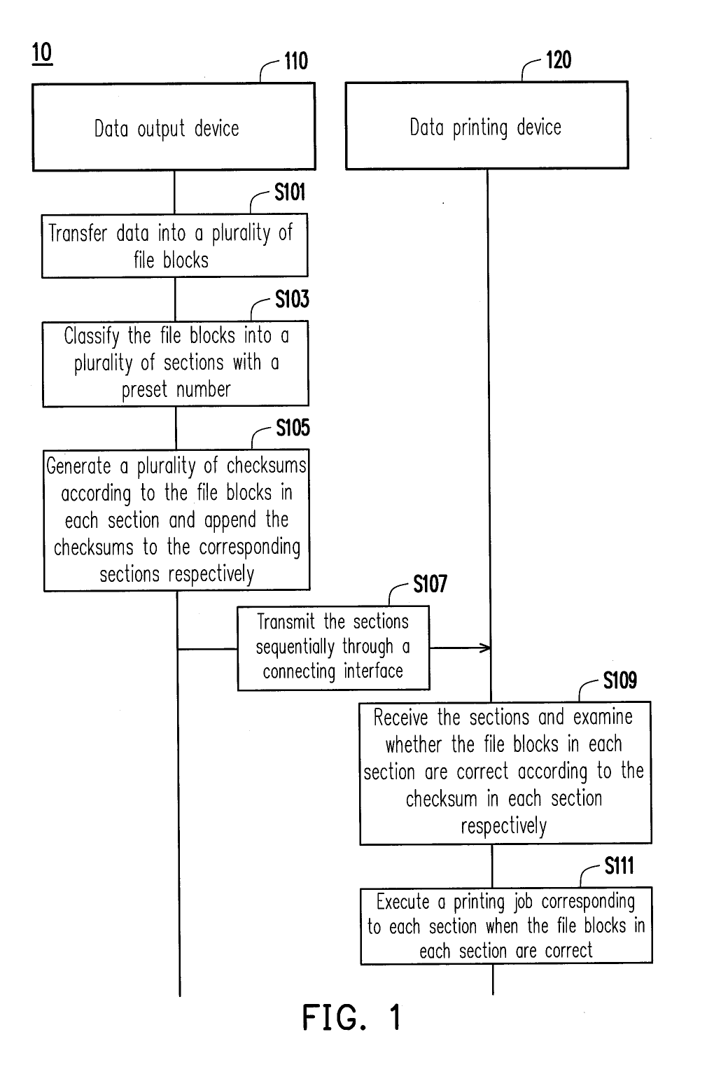

FIG. 1 is a sequential flowchart of a data printing system illustrated according to an embodiment of the invention. Referring to FIG. 1, a data printing system 10 includes a data output device 110 and a data printing device 120. The data output device 110 first transfers data into a printing file that includes a plurality of file blocks (Step S101). Next, the data output device 110 classifies the plurality of file blocks into a plurality of sections sequentially with a preset number (Step S103). Then, the data output device 110 generates checksums according to the file blocks in each section and appends the checksums to the corresponding sections respectively (Step S105). After finishing the above operations, the data output device 110 transmits the plurality of sections sequentially (Step S107).

The data printing device 120 is connected to the data output device 110 through a connecting interface, receives the sections and examines whether the file blocks in each section are correct according to each checksum in each section respectively (Step S109). When the file blocks in each section are correct, the data printing device 120 executes a printing job corresponding to the section (Step S111). By means of the operations described above (determining whether the file blocks are correct according to the checksums), the data printing device 120 avoids executing a printing job with erroneous file blocks, leading to printing unexpected data or causing the printer to crash due to erroneous content of the file blocks.

In the invention, the data output device 110 may be electronic devices capable of file output and file transfer, such as a personal computer (PC), a Notebook PC, a Tablet PC and a smart phone. The data referred to in the processing steps are the data selected by the user for printing through the data output device 110, including contents such as documents or images.

The data printing device 120 may be electronic devices having printout functions, such as a laser printer, an ink jet printer and a multi-functional business machine. The connecting interface for connecting the data output device 110 and the data printing device 120 has different embodiments based on different data output device 110 and data printing device 120. For example, the connecting interface may be an Ethernet, a wireless local area network, a Universal Serial Bus (USB), a firewire interface (IEEE 1394), an external Serial Advanced Technology Attachment (eSATA), a Thunderbolt interface, a PS/2 interface, a COM PORT interface, a blue tooth interface or an RJ45 interface.

Therein, when the sections, i.e. the file blocks, are transmitted from the data output device 110 to the data printing device 120 wirelessly, such as through a wireless local area network or a blue tooth interface, the connecting interface is relatively easily affected by the external environment, causing the conditions of data error (for example, erroneous content of the file blocks) or undelivery of part of the contents (for example, part of the file blocks missing from the sections), and the data printing device 120 cancels the printing job by means of the checksum.

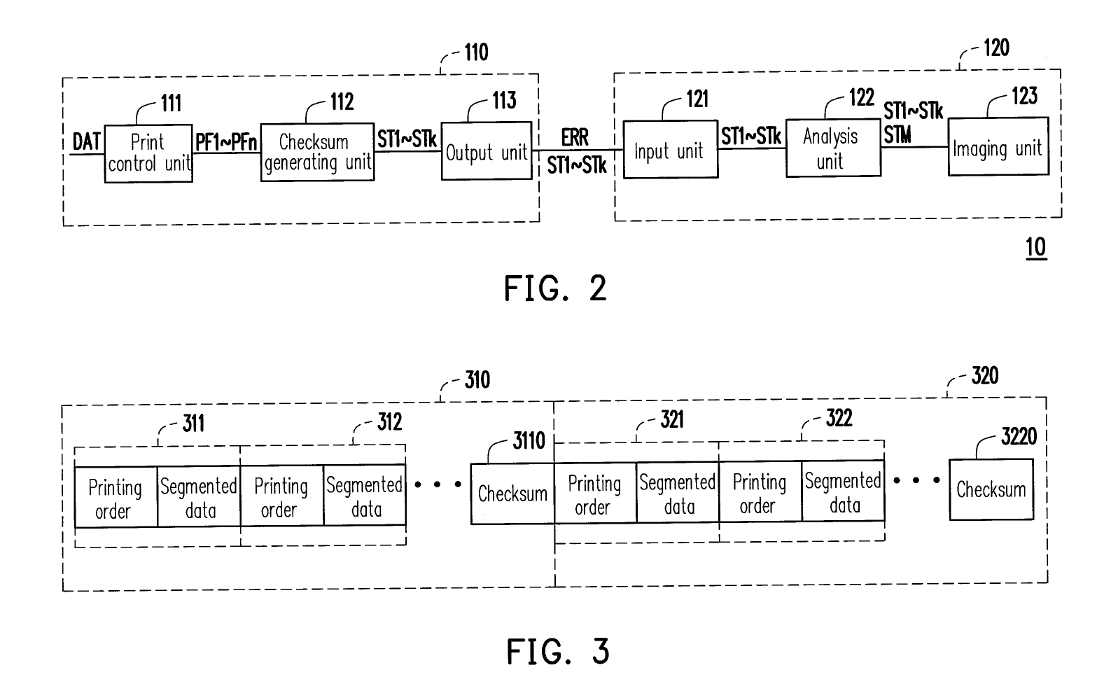

FIG. 2 is a functional block diagram of a data printing system illustrated according to an embodiment of the invention. Compared with the embodiment as shown in FIG. 1, the present embodiment provides a more detailed embodiment of the data output device and the data printing device. Referring to FIG. 2, the data output device 110 includes a print control unit 111, a checksum generating unit 112, and an output unit 113. The print control unit 111 receives data DAT specified by the user for printing, and transfers the data DAT into a printing file that includes file blocks PF1˜PFn. Therein, n corresponds to the number of the file blocks, and the value of n (the amount for printing) varies with the preset size of the file blocks and the size of the data DAT, such as setting a page as a size unit of the file blocks, and the invention is not limited thereto.

According to an embodiment of the invention, the file blocks PF1˜PFn respectively include a printing order and segmented data. The print control unit 111 first segments the data DAT into a plurality of segmented data, such as setting a page or a preset data size as a unit. Next, the print control unit 111 formulates corresponding printing orders based on the content of each segmented data, such as a textual printing order or an image formation printing order. After the printing orders are formulated, the print control unit 111 appends the printing orders respectively before the corresponding segmented data to form the file blocks PF1˜PFn.

The checksum generating unit 112 is coupled to the print control unit 111, and receives the file blocks PF1˜PFn from the print control units 111. The print control unit 111 sequentially classifies the file blocks PF1˜PFn into sections ST1˜STk with a preset number, and generates a plurality of checksums respectively according to the file blocks (part of the file blocks PF1˜PFn) in each of the sections ST1˜STk. After the checksums are generated, the checksums are appended to the corresponding sections ST1˜STk respectively.

In the invention, the checksums may be generated with existing technologies, such as Hamming Code, Cycle Redundancy Check code (CRC code), Message-Digest Algorithm 5 (MD5), or other special algorithms. The checksums are generated with the algorithms using the file blocks in each section as the data to be encoded It is noticed that part of the algorithms for generating checksums may be used for restoring damaged data content. When such algorithms are adopted, an analysis unit 122 may try to restore the content of the file blocks while determining the errors in the file blocks of the sections. But since the complexity of operation and computation using the checksums for error correcting is relatively higher, the operation and computation may be conducted selectively.

The checksum generating unit 112 may be arranged independently with circuits based on the algorithms adopted, or be realized with a processor to coordinate in executing program codes in memory units. Since the print control unit 111 usually has a powerful computing capability, the checksum generating unit 112 may also be co-arranged with the print control unit 111. The present invention is not limited to the above realization.

Referring further to FIG. 2, an output unit 113 is coupled to the checksum generating unit 112, sequentially receives the sections ST1˜STk from the checksum generating unit 112, and transmits the sections ST1˜STk to the data printing device 120 through the connecting interface according to the same sequence.

The data printing device 120 includes an input unit 121, the analysis unit 122 and an imaging unit 123. The input unit 121 is connected to the output unit 113 of the data output device 110 through the connecting interface. The analysis unit 122 is coupled to the input unit 121, controls the input unit 121 to receive the sections ST1˜STk through the connecting interface. The analysis unit 122 sequentially examines whether the file blocks in each of the sections ST1˜STk are correct according to the checksum of each of the sections ST1˜STk respectively. The analysis unit 122 may control the input unit 121 to receive the next section after finishing the analysis of the current section, or the analysis unit 122 may also receive a plurality of sections at one time and save the same in a buffer (not shown). The invention is not limited to the above embodiment.

When the analysis unit 122 determines that the file blocks in the section are correct according to the checksum in one of the sections ST1˜STk, the analysis unit 122 transmits the section to the imaging unit 123. The imaging unit 123 is coupled to the analysis unit 122. When the imaging unit 123 receives a section (one of the sections ST1˜STk) from the analysis unit 122, the imaging unit 123 executes the printing job with the received section. Each of the file blocks in the section includes the printing order and the segmented data. The printing job includes: rendering the segmented data in one of the file blocks according to the printing order in the file block and printing the rendered segmented data.

When the analysis unit 122 determines that the file blocks in the currently analyzed section is erroneous, the analysis unit 122 does not transmit the currently analyzed section to the image formation unit 123. Instead, the analysis unit 122 transmits a canceling message STM to the imaging unit 123. When the imaging unit 123 receives the canceling message STM, the imaging unit 123 cancels the current printing job immediately. According to an embodiment of the invention, when the imaging unit 123 receives the canceling message STM, the imaging unit 123 cancels the printing job after finishing the currently printed section. Since the analysis unit 122 terminates transmitting the section to the imaging unit 123 upon knowing that the section is erroneous, the imaging unit 123 thus ensures that the printing job is not executed with erroneous contents of the section (file blocks).

According to another embodiment of the invention, when the analysis unit 122 determines that the section is erroneous, the analysis unit 122 further transmits a data error message ERR to the data output device 110 through the input unit 121 (for example, transmitting the data error message ERR to the output unit 113 similarly through the connecting interface). The data error message ERR simultaneously includes data content indicating the damaged section, so that the data output device 110 is informed by the data error message ERR which section cannot be printed by the data printing device 120 and that the data need to be retransmitted or the user need to be informed.

FIG. 3 is a schematic data structural view of the sections, file blocks and checksums illustrated according to an embodiment of the invention. Referring to FIG. 3, for the convenience of description, the description about the present figure merely takes two sections (sections 310 and 320) for example. Referring to FIG. 3, the section 310 includes a plurality of file blocks such as file blocks 311 and 312 and a checksum 3110 appended behind the plurality of file blocks. The section 320 also includes a plurality of file blocks such as file blocks 321 and 322 and a checksum 3220 appended behind the plurality of file blocks.

According to an embodiment of the invention, the output unit 113 of the data output device 110 connects the sections with each other (for example, connecting the section 310 with the section 320) and transmits the same to the input unit 121 of the data printing device 120 by streaming. On the other hand, according to another embodiment of the invention, the output unit 113 of the data output device 110 outputs a section (such as the section 310) at one time, and the input unit 121 of the data printing device 120 responds to the output unit 113 with an acknowledgment (ACK) message (not shown) after receiving the section. The output unit 113 continues transmitting the next section (such as the section 320) after receiving the acknowledgment message.

Moreover, the input unit of the data printing device 120 may also be configured that the analysis unit 122 controls the input unit 121 to respond to the output unit 113 with the acknowledgment when the analysis unit 122 analyzes that the content of the current section is not erroneous. Thereby, when the analysis unit 122 determines that the content of the current section is erroneous, the analysis unit 122 instantly controls the input unit 121 to respond to the output unit 113 with the data error message ERR.

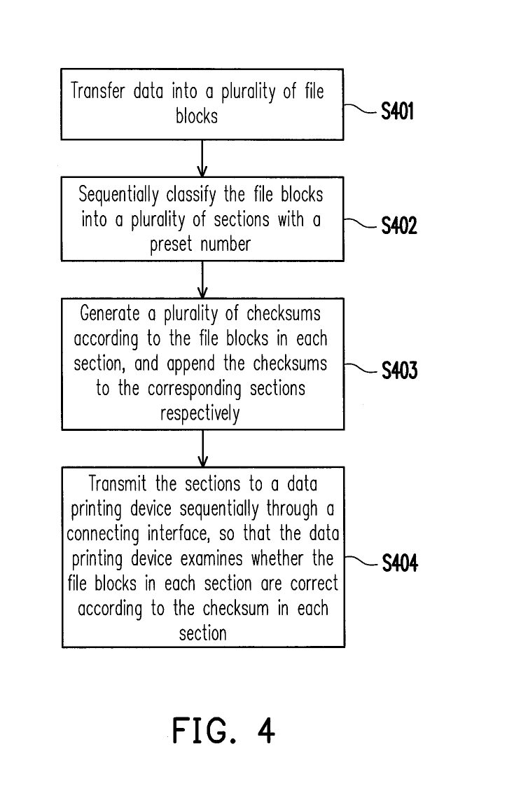

A data printing protection method is further provided, suitable for data output devices having data output functions, such as a personal computer (PC), a Notebook PC, a Tablet PC and a smart phone. FIG. 4 is a method flowchart of a data protection method illustrated according to an embodiment of the invention. Referring to FIG. 4, to begin with, transfer data into a plurality of file blocks in a step S401. Then, sequentially classify the file blocks into a plurality of sections with a preset number in a step S402. Next, generate a plurality of checksums according to the file blocks in each section, and append the checksums to the corresponding sections respectively in a step S403. In a step S404, transmit the sections to a data printing device sequentially through a connecting interface, so that the data printing device examines whether the file blocks in each section are correct according to the checksum in each section. Regarding a detailed description of the method, please refer to the embodiments as shown in FIGS. 1-3, which are not repeated herein.

To sum up, a data printing system and a data protection method are provided, wherein a plurality of file blocks of the printing file are classified into a plurality of sections and checksums are appended to the plurality of sections respectively, so that the data printing device (such as a printer) examines whether the file blocks are correct according to the checksums when receiving the file blocks. Thereby, the data printing device avoids printing unexpected printing contents, or even avoids causing instable conditions such as crashing due to the execution of an erroneous printing order.

Although the disclosure has been described with reference to the above embodiments, it will be apparent to one of the ordinary skill in the art that modifications and variations to the described embodiments may be made without departing from the spirit and scope of the invention. Accordingly, the scope of the disclosure will be defined by the attached claims not by the above detailed descriptions.

What is claimed is:

1. A data printing system, comprising:
a data output device for transferring data into a printing file, wherein the printing file comprises a plurality of file blocks, and the data output device sequentially classifies the file blocks into a plurality of sections with a preset number, generates a plurality of checksums respectively according to the file blocks in each of the sections, appends the checksums to the corresponding section respectively and transmits the sections sequentially; and
a data printing device connected to the data output device through a connecting interface for receiving the sections and examining whether the file blocks in each of the sections are correct according to each of the checksums in each of the sections respectively, wherein the data printing device executes a printing job corresponding to the section when the file blocks of each of the sections are correct.

2. The system according to claim 1, wherein
the data printing device terminates the printing job immediately when the file blocks of each of the sections are incorrect.

3. The system according to claim 2, wherein
the data printing device sends a data error message to the data output device when the file blocks of each of the sections are incorrect.

4. The system according to claim 1, wherein the data output device comprises:
a print control unit for receiving the data and transferring the data into a printing file, wherein the printing file comprises a plurality of file blocks;
a checksum generating unit coupled to the print control unit for receiving the file blocks, sequentially classifying the file blocks into a plurality of sections with a preset number, generating a plurality of checksums respectively according to the file blocks in each of the sections, and appending the checksums to corresponding sections respectively; and
an output unit coupled to the checksum generating unit for receiving the sections sequentially from the checksum generating unit and outputting the sections sequentially through the connecting interface.

5. The system according to claim 1, wherein the data printing device comprises:
an input unit;
an analysis unit coupled to the input unit for controlling the input unit to receive the sections through the connecting interface, wherein the analysis unit analyzes the sections and sequentially examines whether the file blocks in each of the sections are correct according to each of the checksums in each of the sections respectively; and
an imaging unit coupled to the analysis unit, wherein the imaging unit receives the file blocks from the analysis unit and executes the printing job with the file blocks when the file blocks in the sections are correct.

6. The system according to claim 5 wherein
each of the file blocks comprises a printing order and segmented data; and
the printing job comprises the following step: the imaging unit rendering the segmented data in one of the file blocks according to the printing order in the file block and printing the rendered segmented data when receiving the file block.

7. The system according to claim 1, wherein
the connecting interface is an Ethernet, a wireless local area network, a Universal Serial Bus (USB), a firewire interface (IEEE 1394), an external Serial Advanced Technology Attachment (eSATA), a Thunderbolt interface, a PS/2 interface, a COM PORT interface, a blue tooth interface or an RJ45 interface.

8. A data protection method, configured for a data output device, and the method comprises:
transferring data into a printing file, wherein the printing file comprises a plurality of file blocks;
sequentially classifying the file blocks into a plurality of sections with a preset number;
generating a plurality of checksums according to the file blocks in each of the sections and appending the checksums to the corresponding sections respectively; and
transmitting the sections to a data printing device sequentially through a connecting interface, so that the data printing device examines whether the file blocks in the sections are correct according to the checksums in the sections.

9. The method according to claim 8, wherein
each of the file blocks comprises a printing order and segmented data.

10. The method according to claim 8, wherein
the connecting interface is an Ethernet, a wireless local area network, a Universal Serial Bus (USB), a firewire interface (IEEE 1394), an external Serial Advanced Technology Attachment (eSATA), a Thunderbolt interface, a PS/2 interface, a COM PORT interface, a blue tooth interface or an RJ45 interface.
